(19) United States
(12) Patent Application Publication
(10) Pub. No.: US 2011/0017894 A1
(43) Pub. Date: Jan. 27, 2011

(54) MOUNTING MECHANISM FOR RETAINING SLIDE RAIL TO CHASSIS

(75) Inventors: MO-MING YU, Shenzhen City (CN); GUANG-HUA GU, Shenzhen City (CN); LIN-REN GU, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (SHENZHEN) CO., LTD., SHENZHEN CITY (CN); HON HAI PRECISION INDUSTRY CO., LTD., TU-CHENG (TW)

(21) Appl. No.: 12/615,231

(22) Filed: Nov. 9, 2009

(30) Foreign Application Priority Data
Jul. 22, 2009 (CN) 200910304641.5

(51) Int. Cl. F16M 13/00

(52) U.S. Cl. 248/309.1

(57) ABSTRACT

A mounting mechanism is disclosed. The mounting mechanism includes a chassis with an anchor member, a slide rail with a mounting slot defined therein, and a retaining member slidablly attached to the slide rail. The mounting slot is adapted to receive the anchor member. An inclined portion extends from the slide rail. A first end of the retaining member is pivotable attached to the slide rail. A second end of the retaining member retains the anchor member in the mounting slot of the slide rail. The retaining member is rotated to slide along the inclined portion of the slide rail to urge the retaining member to move away from the slide rail, to disengage the anchor member from the second end of the retaining member.

### CROSS-REFERENCE TO RELATED APPLICATION

The relevant subject matter is disclosed in co-pending U.S. patent application Ser. Nos. (Attorney Docket Nos. US28365 and US28443) filed on the same date and entitled “MOUNTING MECHANISM FOR RETAINING SLIDE RAIL TO CHASSIS”, which are assigned to the same assignee as this patent application.

### BACKGROUND

1. Technical Field

The present disclosure relates to mounting mechanisms, and more particularly to a mounting mechanism for mounting a slide rail to a chassis.

2. Description of Related Art

A typical slide rail assembly for a server chassis and a rack includes an outer slide rail mounted to the rack, an inner slide rail mounted to the chassis, and an intermediate slide rail mounted between the outer and inner slide rails. The intermediate slide rail is extendable relative to the outer slide rail, and the inner slide rail is extendable relative to the intermediate slide rail, thereby the chassis can be extended a distance out from the rack. Conventionally, the inner rail is secured to a side of the chassis with a plurality of screws. Therefore, a tool, such as a screwdriver, is needed for installing and detaching the slide rail, and the processes are tedious and time consuming.

### BRIEF DESCRIPTION OF THE DRAWINGS

FIG. 1 is a partial, exploded, isometric view of an exemplary embodiment of a mounting mechanism.

FIGS. 2-5 are assembled, isometric views of the mounting mechanism of FIG. 1, showing different using states.

### DETAILED DESCRIPTION

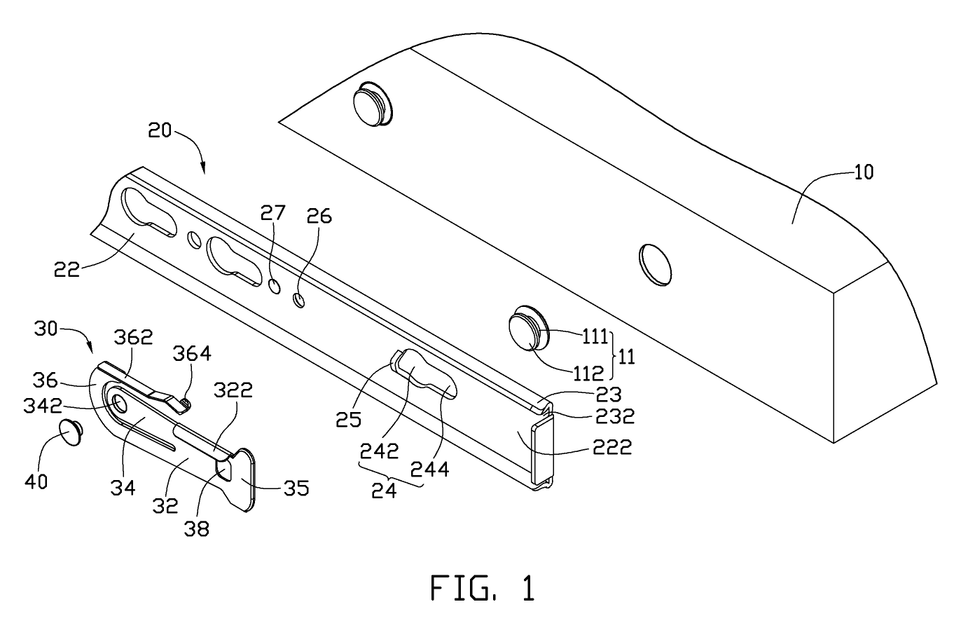

Referring to FIG. 1, an exemplary embodiment of a mounting mechanism includes a slide rail 20, a chassis 10, and a retaining member 30 to mount the chassis 10 to the slide rail 20.

The chassis 10 includes an anchor member 11 mounted to a sidewall of the chassis 10. The anchor member 11 is a mushroom-shaped post, and includes a neck portion 111 and a head portion 112 wider in diameter than the neck portion 111.

The slide rail 20 has a generally C-shaped cross section, and includes a main wall 22 with a first surface 222 opposite to the chassis 10 and two sidewalls 23 extending from opposite sides of the main wall 22 opposite to the chassis 10. A channel 232 is formed between each sidewall 23 and the main wall 22. The main wall 22 defines a mounting slot 24 in the vicinity of one end of the main wall 22. The mounting slot 24 includes a large leading portion 242, and a small positioning portion 244 communicating with the leading portion 242. An inclined portion 25 rising from bottom to top extends from the main wall 22 partially round the leading portion 242, opposite to the positioning portion 244. A coupling hole 26 is defined in the main wall 22 in the vicinity of the mounting slot 24. A bulge 27 is formed extending from the first surface 222 of the main wall 22, adjacent to the coupling hole 26 and opposite to the mounting slot 24.

The retaining member 30 is made of an integrative resilient piece and includes a main body 32, a tongue-shaped pivot portion 34 positioned adjacent to a first end of the main body 32, a stop portion 35 extending from a second end of the main body 32 opposite to the pivot portion 34, and an arc-shaped resilient portion 36 extending from a lower portion of the first end of the main body 32 and around the pivot portion 34. A generally J-shaped channel is formed between the pivot portion 34 and the resilient portion 36. An operating portion 322 extends from an upper portion of the main body 32 and opposite to the slide rail 20. A through hole 342 is defined in the pivot portion 34. A receiving slot 38 is defined in the main body 32 adjacent to the stop portion 35. The resilient portion 36 is generally J-shaped. A resilient piece 362 is bent from a distal end of the resilient portion 36 and opposite to the slide rail 22. A tab 364 extends from a distal end of the resilient piece 362.

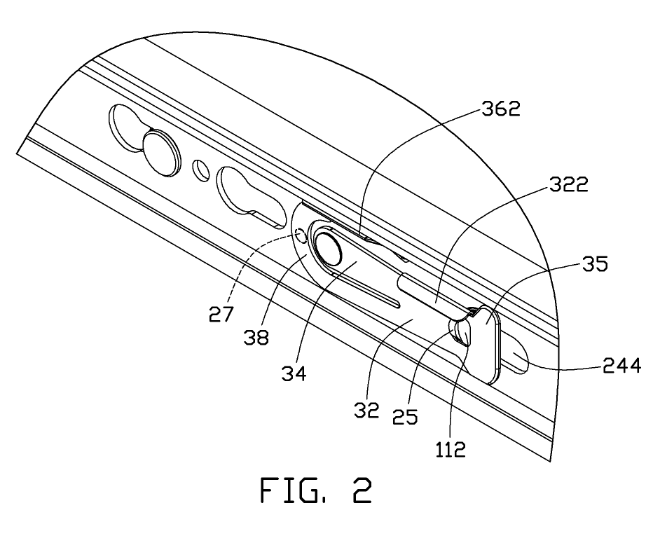

Referring to FIG. 2, in assembly, a fastener 40, such as a rivet, pivotably extends through the through hole 342 of the retaining member 30 to engage in the coupling hole 26 of the slide rail 20, therefore, the retaining member 30 is pivotably attached to the slide rail 20. The inclined portion 25 of the slide rail 20 is received in the receiving slot 38 of the retaining member 30. The stop portion 35 of the retaining member 30 is aligned with the leading portion 242 of the mounting slot 24 of the slide rail 20. The tab 364 of the retaining member 30 engages in the upper channel 232 of the slide rail 20. The bulge 27 of the slide rail 20 abuts against the resilient portion 36 of the retaining member 30 to deform the resilient portion 36, therefore, the main body 32 and the stop portion 35 resist against the first surface 222 of the slide rail 20.

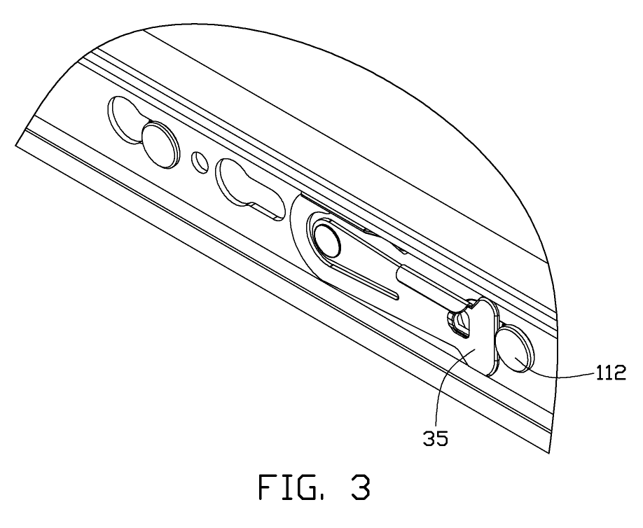

Referring to FIG. 3, to mount the slide rail 20 to the chassis 10, the chassis 10 is moved to fit the neck portion 111 of the anchor member 11 into the mounting slot 24 from the leading portion 242 to the position portion 244. The head portion 112 of the anchor member 11 presses the stop portion 35 of the retaining member 30 to deform the retaining member 30 away from the first surface 222. When the neck portion 111 of the anchor member 11 slides into the positioning portion 244 of the mounting slot 24, the retaining member 30 is restored to make the stop portion 35 engage with the head portion 112 of the anchor member 11, to retain the anchor member 11 in the positioning portion 244 of the mounting slot 24. Thereby, the slide rail 20 is secured to the chassis 10.

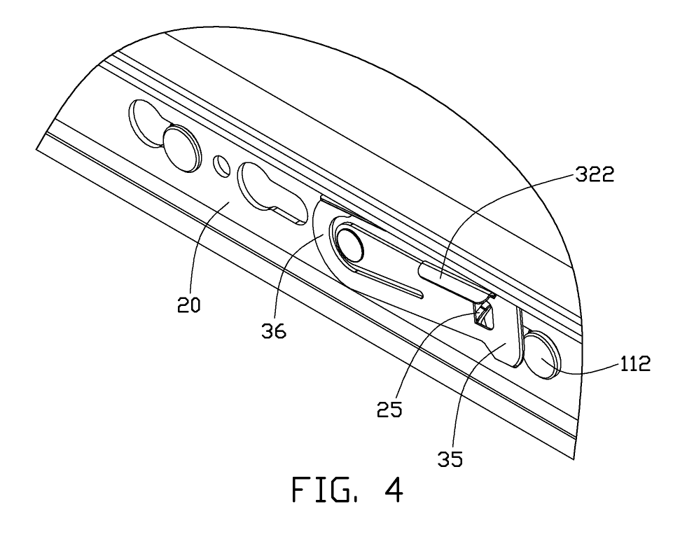

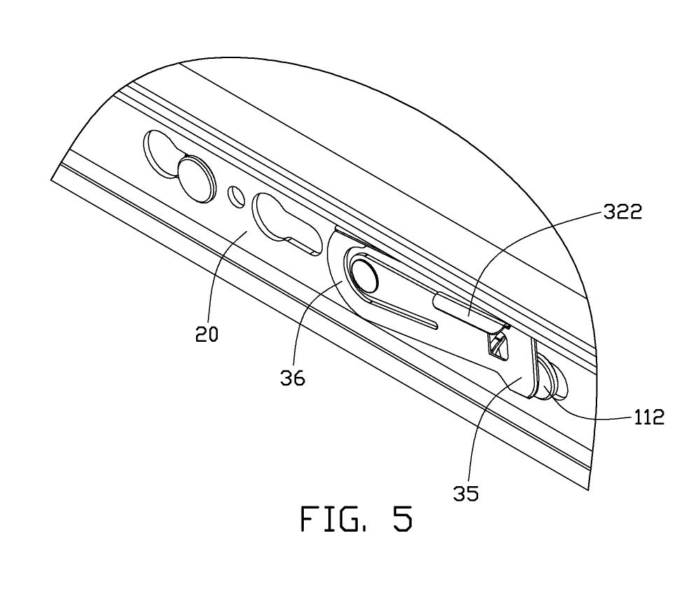

Referring to FIGS. 4-5, to detach the slide rail 20 from the chassis 10, the operating portion 322 is manipulated to pivot upward the retaining member 30 around the fastener 40 in a direction perpendicular to the first surface 222 of the slide rail 20. The main body 32 of the retaining member 30 is slid along the inclined portion 25, to deform the retaining member 30 away from the first surface 222. The stop portion 35 of the retaining member 30 is urged to move away from the first surface 222 of the slide rail 20. The head portion 112 of the anchor member 11 is disengaged from the stop portion 35 of the retaining member 30. The chassis 10 is moved to allow the neck portion 111 of the anchor member 11 to slide out of the positioning portion 244 of the mounting slot 24, and then slide out of the leading portion 242 of the mounting slot 24. Therefore, the slide rail 20 is detached from the chassis 10.

While several embodiments have been disclosed, it is understood that any element disclosed in any one embodiment is easily adapted to other embodiments. It is also to be understood, however, that even though numerous characteristics and advantages of the disclosure have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A mounting mechanism comprising:
a chassis comprising an anchor member protruding from the chassis;
a slide rail comprising a main wall to be attached to the chassis, the main wall defining a mounting slot for receiving the anchor member, an inclined portion extending from the main wall; and
a retaining member comprising a main body, a tongue-shaped pivot portion positioned adjacent to a first end of the main body, and a stop portion extending from a second end of the main body opposite to the pivot portion, wherein the pivot portion of the retaining member is pivotablly attached to the slide rail, the stop portion is operable of retaining the anchor member in the mounting slot of the slide rail;
wherein the retaining member is operable to be rotated to slide the main body along the inclined portion of the slide rail, to urge the retaining member to move away from the slide rail, thereby releasing the anchor member from the stop portion of the retaining member.

2. The mounting mechanism of claim 1, wherein the anchor member is a mushroom-shaped post, and comprises a neck portion connected to the chassis, and a head portion extending from the neck portion, with a diameter larger than a diameter of the neck portion, the neck portion of the anchor member is slidable in the mounting slot of the slide rail, the head portion of the anchor member is engagable with the stop portion of the retaining member.

3. The mounting mechanism of claim 2, wherein the mounting slot comprises a leading portion for the anchor member sliding therein, and a positioning portion for the neck portion of the anchor member being engaged therein.

4. The mounting mechanism of claim 3, wherein the inclined portion raising from bottom to top extends from the main wall of the retaining member round the leading portion of the mounting slot, the main body defines a receiving slot for receiving the inclined portion.

5. The mounting mechanism of claim 1, wherein the retaining member is made of an integrative resilient piece.

6. The mounting mechanism of claim 1, wherein the retaining member further comprises a resilient portion extending from a lower portion of the main body for restoring the retaining member, the resilient member is arranged around the pivot portion, a generally J-shaped channel is formed between the pivot portion and the resilient portion.

7. The mounting mechanism of claim 6, wherein the resilient portion is generally J-shaped.

8. The mounting mechanism of claim 6, wherein a resilient piece is bent from the resilient portion opposite to the slide rail, a tab extends from a distal end of the resilient piece, the slide rail further comprises two sidewalls extending from opposite top and bottom sides of the main wall, a channel is formed between each sidewall and the main wall, the tab of the retaining member engages in the channel at the top of the main wall.

9. The mounting mechanism of claim 1, wherein the retaining member further comprises an operating portion extending from an upper portion of the main body opposite to the slide rail, for rotating the retaining member.

10. A slide rail assembly for mounting a chassis that comprises an anchor member protruding from the chassis, the slide rail assembly comprising:
a slide rail with a mounting slot defined therein, to receive the anchor member, wherein an inclined portion extends from the slide rail; and
a retaining member with a first end of the retaining member pivotably attached to the slide rail, a second end of the retaining member retaining the anchor member in the mounting slot of the slide rail;
wherein the retaining member is operable to be rotated around the first end in a direction perpendicular to the slide rail to slide along the inclined portion of the slide rail to urge the retaining member, to move away from the slide rail to disengage the anchor member from the second end of the retaining member.

11. The slide rail assembly of claim 10, wherein the mounting slot comprises a leading portion for the anchor member entering into the mounting slot, and a smaller positioning portion for the anchor member engaged therein.

12. The slide rail assembly of claim 11, wherein the inclined portion raising from bottom to top extends from the slide rail round the leading portion, the retaining member defines a receiving slot for receiving the inclined portion.

13. The slide rail assembly of claim 10, wherein the retaining member is made of an integrative resilient piece.

14. The slide rail assembly of claim 10, wherein the retaining member comprises a main body, a tongue-shaped pivot portion positioned adjacent to a first end of the main body to pivotably attach the retaining member to the slide rail, a stop portion extending from a second end of the main body opposite to the pivot portion to retain the anchor member in the mounting slot of the slide rail.

15. The slide rail assembly of claim 14, wherein the retaining member further comprises a generally J-shaped resilient portion for restoring the retaining member.

16. The slide rail assembly of claim 14, wherein the slide rail comprises a main wall and a sidewall extending from a side of the main wall, a channel is formed between the sidewall and the main wall, a resilient piece is bent from the resilient portion opposite to the slide rail, a tab extends from a distal end of the resilient piece for engaging in the channel.
